(19) United States
(12) Patent Application Publication
(10) Pub. No.: US 2006/0136405 A1
(43) Pub. Date: Jun. 22, 2006

(54) Searching apparatus and methods

(76) Inventors: Gary M Ducatel, Ipswich (GB); Behnam Azvine, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/543,096

(22) PCT Filed: Jan. 23, 2004
(86) PCT No.: PCT/GB04/00310

§ 371 Date: Jul. 22, 2005

(30) Foreign Application Priority Data
Jan. 24, 2003 (GB) 0301721.7
Apr. 25, 2003 (GB) 0309460.4

(51) Int. Cl. G06F 17/30

(52) U.S. Cl. 707/4

(57) ABSTRACT

An apparatus and method are provided for improving database searching, the method comprising the steps of: receiving a search query comprising one or more search keywords from a user; accessing a user profile means arranged to provide data indicative of relatedness criteria between keywords from a set of documents, and identifying from said user profile means, for the or each search keyword, potentially-related keywords according to predetermined criteria; providing said potentially-related keywords to the user; receiving information from the user confirming that any potentially-related keywords are considered to be related keywords; in the event that any potentially-related keywords are confirmed by the user to be related keywords, incorporating such potentially-related keywords as keywords in an improved search query; and submitting the improved search query to a search engine. Also provided are an apparatus and method for creating and maintaining user profiles for use in the above searching apparatus and method.

### TECHNICAL FIELD

The present invention relates in general to the use of search engines that access databases. In particular, the invention relates to apparatus and methods which allow for the improved use of search engines by creating, maintaining and using user profiles. Embodiments of the present invention may be used in conjunction with existing standard search engines or with specifically configured search engines, and it should therefore be noted that the technical field of the invention relates to the manner in which a user may interact with a system such as a personal computer, and not to the software by which any chosen search engine functions.

An example of an application of the invention is in relation to intranet search engines that access large databases such as large corporate repositories holding legal or medical data sets. It also applies to renewed data repositories such as news sources. Embodiments of the invention would typically be integrated with a search platform utilised by users who wish to access and search large unstructured databases such as intranets or the Internet. Such platforms may have several thousand users.

### BACKGROUND TO THE INVENTION

A system providing an “Intelligent Personalised Agent Framework”, formerly known as “Idioms” is disclosed in M P Thint, B Crabtree & S J Soltysiak: “Adaptive Personal Agents” (Personal Technologies Journal, 2(3):141-151, 1998); and B Crabtree & S J Soltysiak: “Knowing Me, Knowing You: Practical Issues in the Personalisation of Agent Technology”, (PAAM'98 Third International Conference on the Practical Application of Intelligent Agents and Multi-Agent Technology, Mar. 23-25 1998). This system acts as a host to a community of users and provides them with on-line services including news sources or corporate databases. The system offers to the users a personalised experience. With such a system, users may receive a personalised newspaper every day using a search engine that has access to an information source such as “Intellact”, disclosed in B Crabtree & S J Soltysiak: “Automatic Learning of User Profiles—Towards Personalisation of Agent Services” (BT Technology Journal, 16(3):110-117, 1998). I Koychev: “Tracking Changing User Interests Through Prior-Learning of Context” (AH'2002, 2nd International Conference on Adaptive Hypermedia and Adaptive Web Based Systems, 2002); and T Mitchell, R Caruana, D Freitag, J McDermott & D Zabowski: “Experience with a Learning Personal Assistant” (Communications of the ACM, 7(37):81-91, 1994), disclose profile creation systems that are based on decision tree algorithms that have input vectors with a number of features below thirty. In Koychev's approach the application does not only rely on a window based approach but the algorithm attempts to freeze an interest in time and save it for future use. When a new interest is found it is checked against “past interests” to see if it corresponds to an old interest, and if it does, the application merges the old interest into the new one; this augments the new interest with information that is relevant to it. The system enables advantageous learning capabilities. The number of features in a vector may however be orders of magnitude larger; every keyword that has any relevance must be taken into account and consequently the size of a vector rapidly reaches thousands of features.

In order to adapt user profiles to changes in interests there are two main approaches: the window frame and the ageing mechanism. Maintaining interests in a window frame is a solution that is beneficial to discover and maintain a list of recently introduced interests, because they appear fast and distinctively as shown in Crabtree (1998) above. However, the drawback of the window frame approach is that it is difficult to retrieve past interests. Typically, if an interest changes or disappears, it is discarded. This has lead to experiments with optimised “interest forgetting functions” as disclosed in I Koychev: “Gradual Forgetting for Adaptation to Concept Drift” (ECAI 2000 Workshop, Current Issues in Spatio-Temporal Reasoning, pages 101-106, 2000). This method is a function that decreases the influence of an interest in time; old interests gradually disappear as their importance is reduced linearly over a period of time. The classification of the interests is a crisp set that discards interests when the linear function of the “gradual forgetting” process comes to term.

In order to compensate for the large dimensionality of information retrieval it is known to use user feedback in various forms such as the relevance feedback system disclosed in J J Rocchio: “Performance Indices for Information Retrieval” (Prentice Hall, 1971, Soft Computing and Information Organisation, 11), or user rating as disclosed in D Billsus & M Pazzani: “Learning and Revising User Profiles: The Identification of Interesting Web Sites” (Machine Learning, 27:313-331, 1997). One problem related to requiring feedback from users is that in practice users are reluctant to provide any feedback regardless of how valuable it is to their future requests in the system. It seems that users do not want to interact with the search engine once it has returned the results since it is perceived as an annoyance rather than a benefit.

### SUMMARY OF THE INVENTION

According to a first aspect of the invention, there is provided apparatus for creating and maintaining a user profile for a user for improving database searching by the user, said apparatus comprising:

means for accessing a predetermined set of documents containing a plurality of keywords during a learning phase;

analysing means arranged to analyse said documents and to identify, according to predetermined rules, groups of related keywords therein;

attribute assigning means arranged to assign attributes indicative of relatedness to said groups of keywords; and

user profile storing means arranged to store said relatedness attributes as a user profile;

said apparatus further comprising:

document updating means arranged to update the set of documents by adding documents to or subtracting documents from the set during an updating phase;

identifying means arranged to analyse the updated set of documents and to identify existing and additional groups of related keywords therein, according to predetermined rules;

means arranged to assign attributes indicative of relatedness to said additional groups of keywords;

relatedness attribute updating means for updating the relatedness attributes of said existing groups of keywords; and

user profile updating means arranged to update the user profile in accordance with the relatedness attributes of said existing and additional groups of keywords.

There is also provided a method for creating and maintaining a user profile for a user for improving database searching by the user, said method comprising a learning phase and an updating phase, wherein said learning phase comprises the steps of:

accessing a predetermined set of documents containing a plurality of keywords;

analysing said documents and identifying, according to predetermined rules, groups of related keywords therein;

assigning attributes indicative of relatedness to said groups of keywords; and

storing said relatedness attributes as a user profile; and wherein said updating phase comprises the steps of:

updating the set of documents by adding documents to or subtracting documents from the set;

analysing the updated set of documents and identifying existing and additional groups of related keywords therein, according to predetermined rules;

assigning attributes indicative of relatedness to said additional groups of keywords;

updating the relatedness attributes of said existing groups of keywords; and

updating the user profile in accordance with the relatedness attributes of said existing and additional groups of keywords.

The predetermined set of documents is preferably a set of documents expected to reflect the interests of a specific user, such as a sub-set of documents derived from a set of documents previously viewed by a specific user. The complete content of the documents may be stored in a local memory, or access to the full content may be by means of a set of links to internet or intranet locations where the full content is available.

The identification of related keywords from the set of documents may be achieved by means of a self-organising map algorithm, or may use other techniques to identify groups of related keywords. The groups may comprise pairs of words or may be larger groups.

Preferably the types of attributes assigned to groups of keywords include an importance value indicating the statistical significance of related keywords in the set of documents, and a life-span value indicating the expected remaining period of time of relatedness between keywords in the set of documents. Such life-span values may be systematically or automatically decreased over time until such time as the life-span values reach zero, indicating that the respective keywords are not considered to be related anymore. The user may however be given the opportunity to manage the profile manually by adjusting the attributes, for example, or the apparatus may require confirmation before allowing the life-span values in relation to certain keyword groups to reach zero.

Embodiments of the invention in which the user is not required to provide input in order for the user profile to be updated allow for what may be termed “unsupervised learning”. This is advantageous particularly where users are reluctant to provide feedback, regardless of how valuable it is to their future requests in the system.

According to preferred embodiments of the apparatus, the document updating means may be arranged to update the set of documents in response to user input confirming, for example, that new documents are of interest to the user. The updating may be carried out on the basis of documents viewed by the user following receipt of a response from a search engine to a search query. It may also be done without the need for any further input from the user, however.

Preferably, the user profile storing means is arranged to store relatedness attributes in the form of fuzzy sets.

According to a second aspect of the invention, there is provided apparatus for improving database searching, comprising:

user profile means, having access to a predetermined set of documents, arranged to provide data indicative of relatedness criteria between keywords from the set of documents;

means for receiving a search query comprising one or more search keywords from a user;

means arranged to access said user profile means and to identify therefrom, for the or each search keyword, potentially-related keywords according to predetermined criteria;

means arranged to provide said potentially-related keywords to the user;

means for receiving information from the user confirming that any potentially-related keywords are considered to be related keywords;

means arranged to incorporate such potentially-related keywords as keywords in an improved search query in the event that they are confirmed by the user to be related keywords; and

means for submitting the improved search query to a search engine.

There is further provided a method for improving database searching, comprising the steps of:

receiving a search query comprising one or more search keywords from a user;

accessing a user profile means arranged to provide data indicative of relatedness criteria between keywords from a set of documents, and identifying from said user profile means, for the or each search keyword, potentially-related keywords according to predetermined criteria;

providing said potentially-related keywords to the user;

receiving information from the user confirming that any potentially-related keywords are considered to be related keywords;

in the event that any potentially-related keywords are confirmed by the user to be related keywords, incorporating such potentially-related keywords as keywords in an improved search query; and

submitting the improved search query to a search engine.

According to preferred embodiments of the second aspect of the invention, the predetermined set of documents is a set of documents expected to reflect the interests of a specific user, such as a sub-set of documents derived from a set of documents previously viewed by the user. By virtue of this, such embodiments allow personalisation of the system. By use of assigned attributes such as an importance value indicating the statistical significance of related keywords in the set of documents, and a life-span value indicating an expected period of time of relatedness between keywords in the set of documents, personalisation is possible, such that the changing interests of the individual user are reflected.

The user profile means preferably comprises means for identifying related keywords from the set of documents by means of a self-organising map algorithm. Preferably the user profile means is arranged to provide data indicative of relatedness criteria in the form of fuzzy sets.

According to preferred embodiments, the set of documents is updated on the basis of documents viewed by the user following receipt of a response from a search engine to a search query. The updating may be carried out on the basis of documents viewed by the user following receipt of a response from a search engine to a search query, or may be done without the need for further input from the user.

Preferred embodiments of the invention thus aim to improve the performance of an on-line search engine by gathering and maintaining user profiles obtained by analysing the documents that are relevant to the users. Looking at a preferred embodiment in more detail, the system may build and maintain user profiles in a two-fold process. First the system uses an algorithm as disclosed in the A Nürnberger article: “Interactive Text Retrieval Supported by Self-Organising Maps” (Technical report, BTexact Technologies, IS Lab, 2002), to extract contextually related keywords from a set of documents. Secondly, the keywords in the concepts are given attributes: a “life span” and a “relevance value”. The life span indicates to the system when some words within a concept have not been found relevant for some time and therefore should be reduced in importance or removed altogether. The relevance value is a link between two keywords of a concept; this value reflects the strength of the relationship between the two keywords. Users may have control over these parameters. They can decide if words should have a long or a short life span, and if the strength of the relationship between keywords should be strong or weak before they can start appearing in their profiles.

The solution proposed here also offers the users the facility to rebuild a query that is more valuable based on their initial query and their profile. At least a part of the interaction with the system may be performed before the documents are retrieved, when users are more receptive to further interaction with the system.

This application helps users maintain a profile of temporary interests. The system also provides the analysis required to extract keywords that are relevant to help the users build an efficient profile. The analysis is based on personal data and therefore the keywords suggested to the users are all adapted to their profiles.

The system helps in maintaining profiles, allowing the users to have an informed control over their profile. The system is able to identify which are the keywords and concepts that the users need to improve their search. The profile obtained can be used for query expansion. The users can decide if a keyword is negative or positive to their search.

### BRIEF DESCRIPTION OF THE DRAWINGS

Embodiments of the invention will now be described with reference to the accompanying figures in which:

FIG. 1 is a schematic diagram representing the hardware architecture of an embodiment of the invention;

FIGS. 2a and 2b are screen shots of the user interface of an embodiment of the invention, showing the embodiment in use;

FIG. 3 is a schematic illustration of the operation of an embodiment of the invention in response to a user input;

FIG. 4 is a schematic diagram of the functional elements of the system;

FIG. 5 is a flow chart illustrating the embodiment of the invention processing data to produce or maintain a list of user interests;

FIG. 6 is a schematic representation of the processing of the list of interests of FIG. 5 into a plurality of fuzzy sets.

### DESCRIPTION OF THE EMBODIMENTS

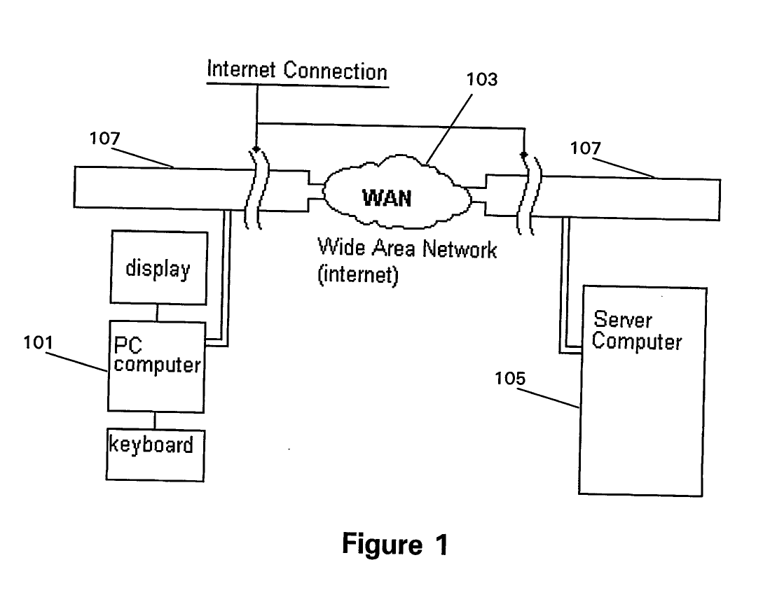

With reference to FIG. 1, a conventional personal computer (PC) 101 is connected to a network 103 such as a wide area network (WAN) or, more specifically, the Internet. Another computer 105 is connected to the WAN 103 and acts as a server computer. The computers 101, 105 may be connected to the WAN 103 via a Local Area Network (LAN) 107 coupled with the access to a gateway server computer (not shown) that enables the computers 101, 105 to access to the WAN 103. Alternatively, the connection 107 may be provided via home Internet access such as broadband and telephone line based access. The PC computer 101, also referred to as the client machine, is arranged to access the server computer 105. The client machine 101 has software to be able to access the WAN 103. The computer 101 has an operating system (e.g. Microsoft Windows™, Unix, or Linux) and a web browser (e.g. Microsoft Internet Explorer™, or Netscape Navigator™).

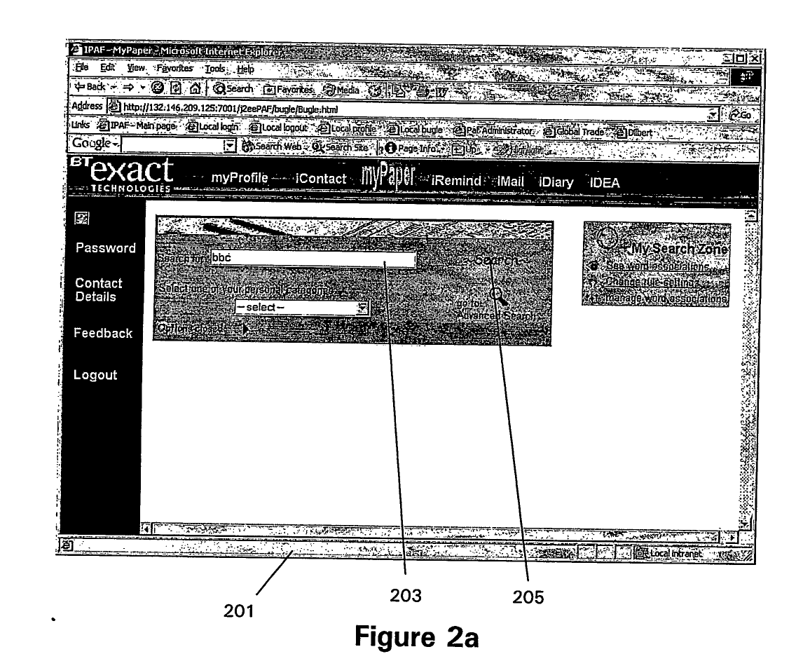

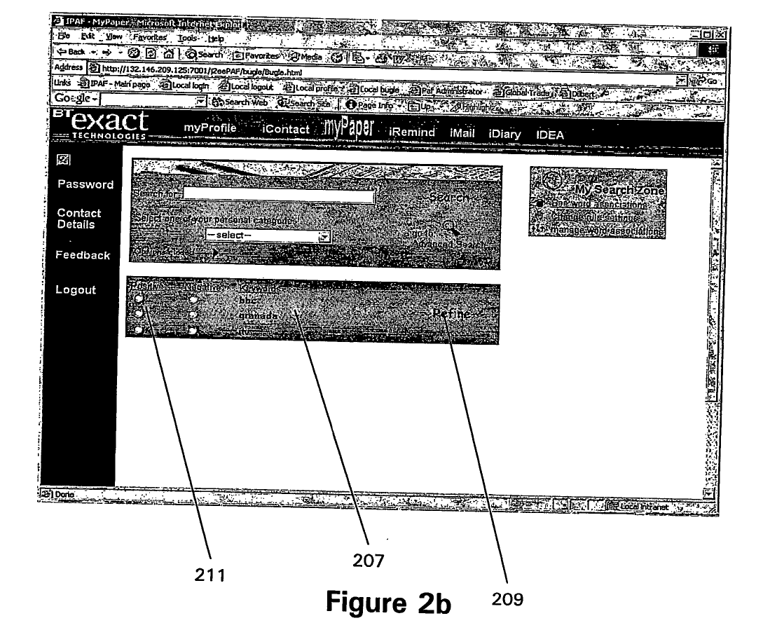

An overview of the user interaction with the system will now be described with reference to FIGS. 2a & 2b. On initiation of the system via a web browser the user is presented with a start page 201 as shown in FIG. 2a. The user can enter a query into the system from a “Search for” box 203 provided. In this example the user enters the acronym for the British Broadcasting Corporation “BBC”. A “Search” button 205 instructs the search engine to execute the entered query. In response to this the system returns a list 207 of alternative keywords as shown in FIG. 2b. In this example the list of keywords 207 comprises the acronyms for some alternative television companies “Granada” and “ITV” as well as the original entry of “BBC”. The list of keywords 207 is provided to assist the users perform a better search. The user can select one or more of the keywords from the list 207 to refine their query and then use the “Refine” button 209 to submit the query. The selection can be either positive or negative i.e. the keywords can be included in the query or specifically excluded via alternative selection indicators 211.

As described above, the system returns the list 207 of alternative keywords prior to retrieving the search results. Alternatively, the system may be arranged to return the results as would be expected from a conventional search engine. Along with the set of results, the application would return the list 207 of alternative keywords.

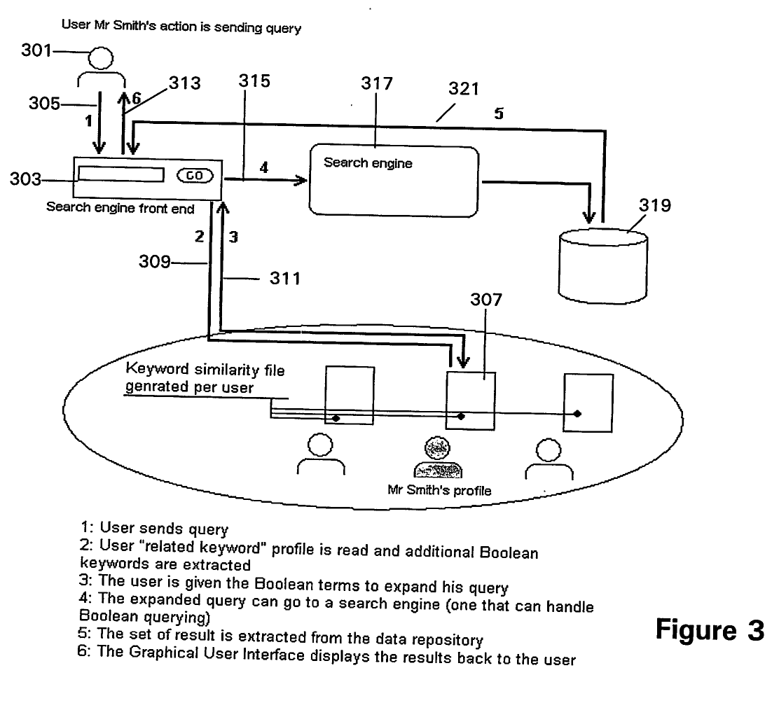

The process described above with reference to FIGS. 2a & 2b is summarised in FIG. 3. The user 301 enters the query into the system 303 at step 305 and system 303 then accesses the user profile 307 for that user at step 309. The system then generates a list of keywords from the profile 307 at step 311 and returns them to the user 301 at step 313 as described above with reference to FIG. 2b. The user makes their choice of refining the search using the list 207 of keywords and the system executes the query or search at step 315 taking into account the users refinements using the search engine 317 and the database 319. The results are then displayed to the user at step 321 via the system front end.

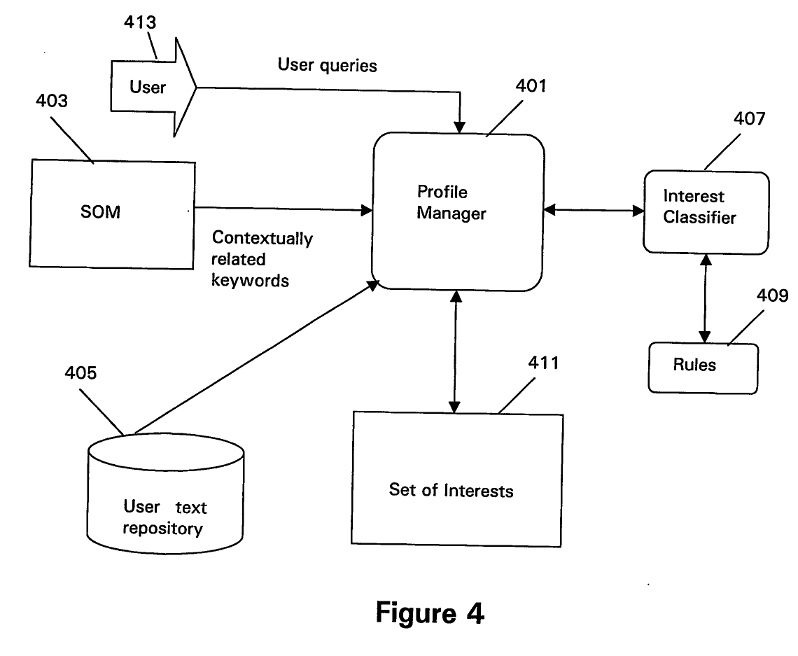

With reference to FIG. 4, the core of the system is a profile manager 401 that operates in two phases. The first phase uses a word group extraction system 403 to identify related keywords from a repository of documents 405. The repository 405 is a set of documents that are expected to reflect the users' interests. The extracted groups of related keywords are representative of those interests of a given user. Each user of the system has a document repository 405 which can be maintained either by the user or an automatic document retriever (not shown). The processing of the contents of the repository 405 to extract the related keywords may be performed off-line. The operation of the word group extraction system 403 will be described further below. The second phase is the classification of the related keywords or interests extracted using an interest classifier 407. The interest classifier 407 uses a set of rules 409 to classify interests by their statistical significance (importance) in the corpus of text in the repository 405 and by their age (life span). The operation of the interest classifier 407 will be described further below.

The output of the profile manager 401 is a set of interests 411 classified by their importance in the repository 405 and life span. The profile manager 401 then uses the set of interests 411 in response to the input of a query 413 (203, 205 in figure 2a) to provide the user with a list of keywords (207 in FIG. 2b). The management and maintenance of the interests is carried out by the profile manager in accordance with a set of rules which will be described below. The management includes updating the interests from time to time and removing old or outdated interests. The interests 411 are used to refine the search as described above. The set of interests 411 may also be referred to as the user profile. In some situations the profile may include other data describing the users interests and or preferences. The profile manager 401 requires a set of interests 411 before it can provide a list of key words in response to a user query. As a result, the system needs to go through a learning process while the set of interests is initially set up.

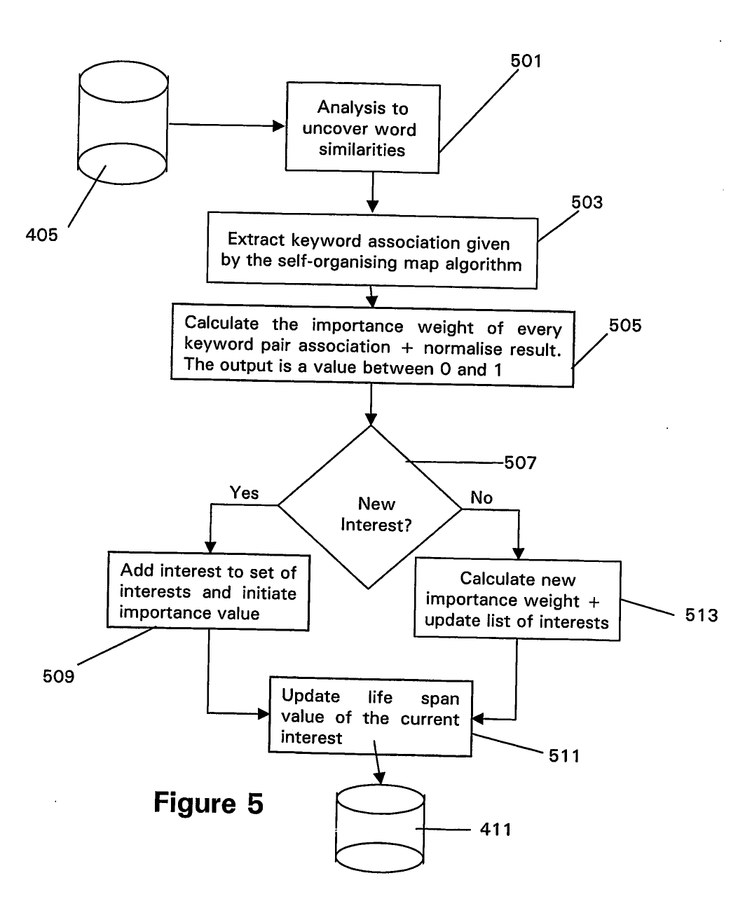

The process carried out by the profile manager 401 described above will now be described in further detail with reference to the flow chart of FIG. 5. At step 501 the profile manager 401 uses the word group extraction system 403 to identify contextually related keywords within bodies of text in the repository 405. The word group extraction system 403 uses a Self-Organising Map (SOM) algorithm disclosed in T Kohonen: “Self-Organising and Associative Memory” (Springer-Verlag, 1984). The input to the SOM is word triples (represented in a numerical format). The SOM produces a representation of the input words in clusters on a conceptual two-dimensional map where strongly related keywords appear close to one another. For example, if a, b, x and y are words that can be found in a text corpus T, if the following two word arrangements are frequent across T: a x b, and a y b, then a and b are contextually related keywords.

At step 503 the output of the SOM algorithm is extracted as a list of contextually related keywords. The list is represented by a number N of items made of keywords A (a,b,c), B (d,e,f) . . . N (x,y,z), where the upper case letters represent sets of related keywords or interests and lower case letters simply represent keywords. The set of interests can be seen as a personalised ontology. Every keyword is associated with the keywords that are statistically related to it.

Processing then moves to step 505 at which the profile manager 401 assigns each interest an initial importance value and a life span value. The importance value is initially set up as the average Inverse Document Frequency (IDF) value of every keyword of the interest as disclosed in K Sparck Jones: “Index Term Weighting” (Information Storage and Retrieval, (9):313-316, 1973). The IDF value of a given keyword reflects its statistical importance in a given text corpus (in this case the user document repository 405). This importance value is normalised so that the weight can be expressed as a percentage value.

Processing then moves to step 507 where the interest classifier 407 takes each interest in turn and determines whether it is a new interest or an existing interest. If the interest is a new interest processing moves to step 509.

At step 509, if the interest is the first interest for a new set of interests 411 then the profile manager 401 creates a new set and the interest is added to it. If the interest is an addition to an existing set 411 then it is simply added to the set 411.

If at step 507 the new interest is identified as an existing interest in the set 411 then processing moves to step 513. At step 513 each keyword of the new interest is taken in turn, and if the keyword is part of the existing interest then its weight is increased by a factor x. In the present embodiment the increase is linear and the factor is set to 1.3. If a keyword in the new interest is not present in the existing interest then it is given a weight of 1. Once each keyword in the new interest has been processed in this way the weights are normalised and the system is able to express the weights as a value between 0 and 1.

At step 511 the profile manager 401 gives each interest a life span expressed in days. In the present embodiment this is set to 60 days. A renewed interest is automatically reclassified with a 60 day or full life span. The new or updated interests are then added to the set of interests 411. The existing interest is then replaced with the new or updated interest in the set of interests 401.

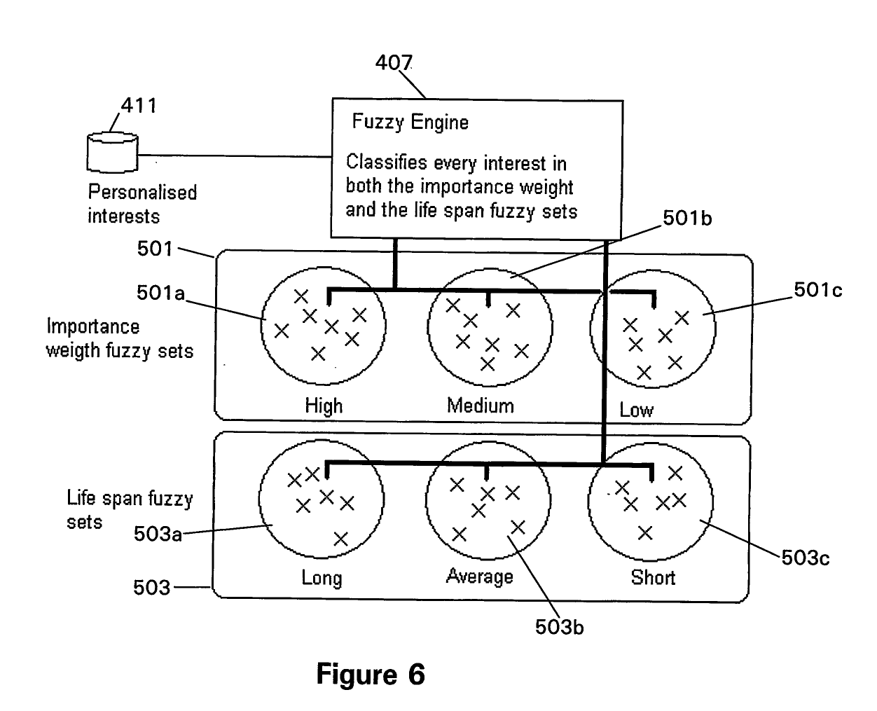

Once the profile manager 401 has produced or updated a set of interests 411 it then utilises the interest classifier 407 to process the interests 411 further. With reference to FIG. 6, the input into the interest classifier is the set of interests 411 and the set of rules 409. The interest classifier 407 outputs the set of interests classified into two fuzzy sets 501, 503. Every interest is classified into one of the three life span fuzzy sets 503a, 503b, 503c and into one of the three importance weight fuzzy sets 501a, 501b, 501c. The classification of each interest depends on the life span and importance weights assigned to each interest in steps 505, 509, 511 and/or 513 of FIG. 5 as described above.

As noted above, an interest is given an initial life span (step 511 in FIG. 5) and is classified into one of three fuzzy sets by the interest classifier 407. If the initial classification is “long” the interest will be sustained in the system for at least as long as the system is initially set up to (sixty days in the current implementation). This classification is reviewed on a regular basis by the fuzzy engine such as when concepts are updated or added. If the interest is not renewed its lifespan will result in a gradual downgrading to the “average” set, then to the “short” set and finally will be removed from the set of interests 411. In other words, the classification of an interest into a life span fuzzy set is an indication of its life span expectancy in the system.

The users may have access to the fuzzy sets configuration through an interface to enable them to control the classification process. The users can modify the size of the life span sets 503a, 503b, 503c and thus modify the life span of concepts. To keep concepts longer the fuzzy set of recent concepts 503a can be increased and the sizes of one or more of the sets of older concepts 503b, 503c reduced. The importance fuzzy sets 501a, 501b, 501c are used in the selection of keywords that will be suggested to a user in response to the entry of a query. For example, the system may be arranged to suggest only strong interests, strong and medium interest or all interests. Again the users can decide on the size of these data sets so that they have control over the selection process. Similarly the system 401 is arranged so that if the system is about to discard a concept with strong relevance (because its life span has expired) the system can require confirmation from the user. This gives the user the facility to renew the lifespan of the interest if they choose.

Interests that have had their importance value renewed (step 513 of FIG. 5) may well remain in the same fuzzy set or they may be upgraded. Others that have not been renewed may either be sustained a little longer in the same set or they may be downgraded. An interest with an updated importance value is not automatically reclassified in the “high” fuzzy set, others are gradually downgraded to the “medium” and the “low” sets.

The system is designed to help the users manage their profile efficiently. Yet, the system can run without requiring the users to maintain anything. Users are also allowed to add, change, and remove concepts. They can thoroughly control their sets of interests 411, repositories 405 and rules 409. The system provides a non-obtrusive software application. The application gradually builds fuzzy sets of keywords and is able to make helpful suggestions to the users. By giving control to the users with regards to the size of the fuzzy sets they can manage the maintenance of the profiles and they can build more efficient queries.

Self organising maps are discussed further in T Kohonen: “Self-Organized Formation of Topologically Correct Feature Maps” (Biological Cybernetics, 43:59-69, 1982); and H Ritter & T Kohonen: “Self-Organising Semantic Maps” (Biological Cybernetics, 61(4):241-254, 1989).

It will be understood by those skilled in the art that the apparatus that embodies the invention could be a general purpose device having software arranged to provide an embodiment of the invention. The device could be a single device or a group of devices and the software could be a single program or a set of programs. Furthermore, any or all of the software used to implement the invention can be contained on various transmission and/or storage mediums such as a floppy disc, CD-ROM, or magnetic tape so that the program can be loaded onto one or more general purpose devices or could be downloaded over a network using a suitable transmission medium.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. Apparatus for creating and maintaining a user profile for a user for improving database searching by the user, said apparatus comprising:
means for accessing a predetermined set of documents containing a plurality of keywords during a learning phase;
analysing means arranged to analyse said documents and to identify, according to predetermined rules, groups of related keywords therein;
attribute assigning means arranged to assign attributes indicative of relatedness to said groups of keywords; and
user profile storing means arranged to store said relatedness attributes as a user profile; said apparatus further comprising:
document updating means arranged to update the set of documents by adding documents to or subtracting documents from the set during an updating phase;
identifying means arranged to analyse the updated set of documents and to identify existing and additional groups of related keywords therein, according to predetermined rules;
means arranged to assign attributes indicative of relatedness to said additional groups of keywords;
relatedness attribute updating means for updating the relatedness attributes of said existing groups of keywords; and
user profile updating means arranged to update the user profile in accordance with the relatedness attributes of said existing and additional groups of keywords.

2. Apparatus according to claim 1, wherein the predetermined set of documents is a set of documents expected to reflect the interests of a specific user.

3. Apparatus according to claim 1, wherein the predetermined set of documents is a set of documents derived from a set of documents previously viewed by a specific user.

4. Apparatus according to claim 1, wherein the analysing means comprises means for identifying groups containing pairs of related keywords.

5. Apparatus according to claim 1, wherein the analysing means comprises means for identifying related keywords from the set of documents by means of a self-organising map algorithm.

6. Apparatus according to claim 1, wherein the attribute assigning means comprises importance value assigning means for assigning importance values indicating the statistical significance of related keywords in the set of documents.

7. Apparatus according to claim 1, wherein the attribute assigning means comprises means for assigning life-span values indicating the expected remaining period of time of relatedness between keywords in the set of documents.

8. Apparatus according to claim 7, wherein said relatedness attribute updating means comprises means for systematically decreasing the life-span values over time.

9. Apparatus according to claim 1, wherein the document updating means is arranged to update the set of documents in response to user input.

10. Apparatus according to claim 9, wherein the document updating means is arranged to add new documents to the set of documents in the event of user input confirming that said new documents are of interest to the user.

11. Apparatus according to claim 1, wherein the user profile storing means is arranged to store said relatedness attributes in the form of fuzzy sets.

12. A method for creating and maintaining a user profile for a user for improving database searching by the user, said method comprising a learning phase and an updating phase, wherein said learning phase comprises the steps of:
accessing a predetermined set of documents containing a plurality of keywords;
analysing said documents and identifying, according to predetermined rules, groups of related keywords therein;
assigning attributes indicative of relatedness to said groups of keywords; and
storing said relatedness attributes as a user profile;
and wherein said updating phase comprises the steps of:
updating the set of documents by adding documents to or subtracting documents from the set;
analysing the updated set of documents and identifying existing and additional groups of related keywords therein, according to predetermined rules;
assigning attributes indicative of relatedness to said additional groups of keywords;
updating the relatedness attributes of said existing groups of keywords; and
updating the user profile in accordance with the relatedness attributes of said existing and additional groups of keywords.

13. A method according to claim 12, wherein groups containing pairs of related keywords are identified.

14. A method according to claim 12, wherein related keywords are identified from the set of documents by means of a self-organising map algorithm.

15. A method according to claim 12, wherein the step of assigning attributes comprises assigning importance values indicating the statistical significance of related keywords in the set of documents.

16. A method according to claim 12, wherein the step of assigning attributes comprises assigning life-span values indicating the expected remaining period of time of relatedness between keywords in the set of documents.

17. A method according to claim 16, wherein the step of updating the relatedness attributes comprises a step of systematically decreasing the life-span values over time.

18. A method according to claim 12, wherein the step of updating the set of documents comprises updating the set of documents in response to user input.

19. A method according to claim 18, wherein the step of updating the set of documents comprises adding new documents to the set of documents in the event of user input confirming that said new documents are of interest to the user.

20. A method according to claim 12, further comprising a step of updating the set of documents on the basis of documents viewed by the user following receipt of a response from a search engine to a search query.

21. A method according to claim 12, wherein said relatedness attributes are stored in the form of fuzzy sets.

22. Apparatus for improving database searching, comprising:
user profile means, having access to a predetermined set of documents, arranged to provide data indicative of relatedness criteria between keywords from the set of documents;
means for receiving a search query comprising one or more search keywords from a user;
means arranged to access said user profile means and to identify therefrom, for the or each search keyword, potentially-related keywords according to predetermined criteria;
means arranged to provide said potentially-related keywords to the user;
means for receiving information from the user confirming that any potentially-related keywords are considered to be related keywords;
means arranged to incorporate such potentially-related keywords as keywords in an improved search query in the event that they are confirmed by the user to be related keywords; and
means for submitting the improved search query to a search engine.

23. Apparatus according to claim 22, wherein the predetermined set of documents is a set of documents expected to reflect the interests of a specific user.

24. Apparatus according to claim 22, wherein the predetermined set of documents is a set of documents derived from a set of documents previously viewed by the user.

25. Apparatus according to claim 22, wherein the user profile means comprises means for identifying related keywords from the set of documents by means of a self-organising map algorithm.

26. Apparatus according to claim 22, wherein the user profile means comprises importance value deriving means for deriving importance values indicating the statistical significance of related keywords in the set of documents.

27. Apparatus according to claim 22, wherein the user profile means comprises means for assigning life-span values indicating an expected period of time of relatedness between keywords in the set of documents.

28. Apparatus according to claim 22, wherein the user profile means is arranged to provide said data indicative of relatedness criteria in the form of fuzzy sets.

29. Apparatus according to claim 22, further comprising means for updating the set of documents on the basis of documents viewed by the user following receipt of a response from a search engine to a search to a search query.

30. Apparatus according to claim 22, wherein the user profile means further comprises means for updating the data indicative of relatedness criteria on the basis of information received from the user.

31. A method for improving database searching, comprising the steps of:
receiving a search query comprising one or more search keywords from a user;
accessing a user profile means arranged to provide data indicative of relatedness criteria between keywords from a set of documents, and identifying from said user profile means, for the or each search keyword, potentially-related keywords according to predetermined criteria;
providing said potentially-related keywords to the user;
receiving information from the user confirming that any potentially-related keywords are considered to be related keywords;
in the event that any potentially-related keywords are confirmed by the user to be related keywords, incorporating such potentially-related keywords as keywords in an improved search query; and
submitting the improved search query to a search engine.

32. A method according to claim 31, wherein the user profile means is arranged to identify said data indicative of relatedness criteria by means of a self-organising map algorithm.

33. A method according to claim 31, wherein the user profile means is arranged to provide importance values indicating the statistical significance of related keywords in the set of documents.

34. A method according to claim 31, wherein the user profile means is arranged to provide life-span values indicating an expected period of time of relatedness between keywords in the set of documents.

35. A method according to claim 31, wherein the user profile means is arranged to provide said data indicative of relatedness criteria in the form of fuzzy sets.

36. A method according to claim 31, further comprising the step of updating the set of documents on the basis of documents viewed by the user following receipt of a response from a search engine to a search to a search query.

37. A method according to claim 31, further comprising the step of updating the data indicative of relatedness criteria on the basis of information received from the user.
